(19) United States
(12) Patent Application Publication
(10) Pub. No.: US 2025/0390278 A1
(43) Pub. Date: Dec. 25, 2025

(54) TRUE RANDOM NUMBER GENERATION CIRCUIT

(71) Applicant: Commissariat à l'Energie Atomique et aux Energies Alternatives, PARIS (FR)

(72) Inventors: Florian PEBAY-PEYROULA, GRENOBLE (FR); Licinius-Pompiliu BENEA, GRENOBLE (FR)

(21) Appl. No.: 19/245,042

(22) Filed: Jun. 20, 2025

(30) Foreign Application Priority Data
Jun. 25, 2024 (FR) 2406833

(51) Int. Cl. G06F 7/58

(52) U.S. Cl. CPC G06F 7/588

(57) ABSTRACT

The present description concerns a circuit (3). First and second identical ring oscillators (R1, R0) deliver first and second periodic signals (S1, S0). A flip-flop (102) samples the first signal (S1) at the beginning of each period of the second signal (S0). A counter (COUNTER) is clocked by the second signal (S0). A metastability management circuit (GM) removes output values (N) of the counter resulting from metastabilities of the first flip-flop (102), and resets the counter (COUNTER) at each rising edge and/or at each falling edge of an output (Beat) of the first flip-flop (102).

### FIELD

The present disclosure generally concerns electronic circuits, and more particularly a true random number generation circuit.

### BACKGROUND

A true random number generation circuit uses an entropy source to generate true random numbers, for example to generate a bit of a true random number.

Known entropy sources are based on the metastabilities that can occur in a flip-flop, for example a D-type flip-flop, when a signal sampled by the flip-flop has an edge, that is, a change in binary value, which is too close to an edge of a clock signal which triggers the sampling.

Other known entropy sources are based on the jitter of ring oscillators. Such is the case, for example, for coherent sampling ring oscillator-based true random number generation circuits designated with the acronym “COSO TRNG”.

FIG. 1 shows an example of a coherent sampling ring oscillator-based true random number generator circuit 1. FIG. 1 more particularly shows a portion of a COSO-type true random number generation circuit, where the elements enabling to generate a random bit from a counter output value N are not illustrated.

Circuit 1 comprises two identical ring oscillators R1 and R0. Oscillator R1, respectively R0, delivers a periodic output signal S1, respectively S0. Signal S1, respectively S0, has a period T1, respectively T0. In particular, since oscillators R0 and R1 are identical, periods T1 and T2 are similar, or, in other words, the ratio of the frequencies of the two oscillators R0 and R1 is, for example, smaller than 1.5.

Circuit 1 further comprises a synchronous flip-flop (FF) 102, for example of type D. Flip-flop 102 is configured to sample signal S1 at the frequency of signal S0.

In other words, flip-flop 102 is configured to update an output signal Beat at each beginning of a period of signal S0 with the binary value of signal S1, each beginning of a period of signal S0 corresponding to an active edge of signal S0, for example a rising edge. Between two successive updates of signal Beat, signal Beat is maintained at its current value, that is, the value taken by signal Beat during the first one of the two successive updates.

For example, flip-flop 102 comprises a data input D configured to receive signal S1, an input CK for synchronizing (clocking) the updates of signal Beat configured to receive signal S0, and an output Q configured to deliver signal Beat.

The two oscillators R1 and R0 and flip-flop 102 form an entropy source 100. The randomness extracted from entropy source 100 is generated from the value of the period T of signal Beat. Signal Beat is a periodic signal having an average period Tm with an average duration Nm in number of periods of signal S0 inversely proportional to the difference between periods T1 and T0, according to the formula Nm=T1/(T1−T0). Signal Beat has an instantaneous period T which varies along with the jitter of signal S1. Thus, the measurement of period T, that is, of the duration of period T, is representative of the jitter of signal S1.

Signal Beat is said to be representative of the phase between signals S1 and S0, for example, since it takes a first binary value, respectively a second binary value, as long as the phase between signals S1 and S0 is such that each active edge of signal S0 occurs while signal S1 is at a first binary level, respectively at a second binary level.

To measure the period T of signal Beat, circuit 1 comprises a circuit (or counter) COUNTER. Circuit COUNTER is configured to deliver, for each period T of signal Beat, a value N, for example in the form of a digital word, equal to the number of periods T0 of signal S0 counted during the period T of signal Beat. In other words, circuit COUNTER is configured to measure the duration of each period T of signal Beat in number N of periods T0 of signal S0.

As an example, circuit COUNTER comprises a reset input R receiving signal Beat, a synchronization input C receiving signal S0, and an output O delivering the counted values N. At each beginning of a period T0 of signal S0, for example at each rising edge of signal S0, circuit COUNTER increments the current count value by one unit. At each beginning of a period T of signal Beat, for example at each rising edge of signal Beat, circuit COUNTER resets the current count value to zero. Preferably, the value N available at the output of circuit COUNTER, on output O, is updated based on the current count value at each resetting of counter COUNTER by signal Beat, just before this current count value is reset to zero. In other words, the value N available at the output of circuit COUNTER is updated at each resetting of counter COUNTER by signal Beat, with the value of the number of periods TO of signal S0 counted since the previous resetting, and the current output value N of counter COUNTER is maintained until the next resetting of counter COUNTER. In other words, preferably, counter COUNTER comprises a register receiving the current count value as a data signal and signal Beat as a clock signal, and delivering value N as an output signal, this register being configured to update value N at each resetting of the current count value, just before this current count value is reset to zero.

Although this not illustrated in FIG. 1, as an example, circuit 1 further comprises a circuit configured to control or modify the period of at least one of the two oscillators RI and R0 so that the difference between periods T1 and T0 is equal to a target difference. The modification of the period T1 of oscillator R1 and/or of the period T0 of oscillator R0 by this circuit is, for example, implemented based on the output values N of circuit COUNTER. For example, for a target value Nmt of the average number Nm of periods T0 per period T of signal Beat, if output value N is smaller than Nmt, the difference between periods T1 and T0 is decreased, and if output value N is greater than Nmt, the difference between periods T1 and T0 is increased.

For example, when both oscillators R1 and R0 are implemented in complementary metal oxide semiconductor (CMOS) technology on semiconductor on insulator (SOI), preferably on fully depleted silicon on insulator, the modification of the period T1 of oscillator R1, respectively of the period T0 of oscillator R0, may be implemented by controlling the back gates of at least one delay element, for example an inverter, of oscillator R1, respectively R0. An example of such a control of the deviation between the periods of two ring oscillators of a COSO-type true random number generation circuit is described in more detail in French patent application FR 3 140 968,European patent application EP 4 354 279 A1, and US patent application US 2024-0128957 A1.

As other examples, whether or not oscillators R1 and R0 are implemented in CMOS on SOI or FDSOI, the modification of the period T1 of oscillator R1, respectively of the period T0 of oscillator R0, is implemented in other ways, for example by selecting one oscillation propagation path among several possible ones, or by modifying the oscillator power supply conditions. As an example, the article by A. Peetermans, V. Rozic, and I. Verbauwheden entitled “A Highly-Portable True Random Number Generator Based on Coherent Sampling”, published in 2019 in 29th International Conference on Field Programmable Logic and Applications (FPL) describes another example of adjustment of the relative periods of two ring oscillators.

However, the use of back gates to modulate the period of at least one of oscillators R1 and R0 when the latter are implemented in CMOS on SOI or FDSOI allows a greater adjustment dynamic range and an improved accuracy in the adjustment of the difference between periods T1 and T0.

Still as other examples, circuit 1 may be devoid of a circuit for adjusting the difference between periods T1 and T0.

In circuit 1, in each of the oscillators R0 and R1, the ratio R of the oscillator period to its jitter can be determined and depends on the technology used to implement the oscillators. When the oscillators are implemented in CMOS on FDSOI, this ratio R is, for example, in the order of 1,000. In practice, for a given technology, this ratio can be obtained by a phase of characterization, for example of a plurality of circuits.

Further, in circuit 1, the measurement accuracy is determined by the difference between periods T1 and T0. More concretely, the measurement accuracy is equal to 1/Nm.

A sufficient measurement accuracy is, for example, achieved when Nm is substantially equal to R. However, in other examples, a measurement accuracy where Nm is smaller than R may be sufficient. Those skilled in the art are capable of determining a target measurement accuracy according to the application.

There exist known stochastic models of the entropy source 100 of circuit 1, for example models mathematically defining the entropy based on the phase noise. These stochastic models are used to characterize entropy source 100, and thus true random number generator device 1. Such a characterization is, for example, necessary to obtain a certification of device 1, for example according to the AIS20/31 standard.

However, in FIG. 1, when an edge of signal S1 occurs during a setup duration or time preceding an edge of signal S0 triggering the sampling of signal S1 by flip-flop 102, or during a hold duration or time following an edge of signal S0 triggering the sampling of signal S1 by flip-flop 102, flip-flop 102 may find itself in a metastable state, and the output Beat of flip-flop 102, that is, the sample delivered by flip-flop 102, may then take a false value, which does not correspond to the value of signal S1 at the time of the edge of signal S0 triggering the sampling. This metastability phenomenon, although it is used as an entropy source in true random number generator devices, is not taken into account in known stochastic models of entropy source 100.

As a result, a hardware implementation of entropy source 100, which expresses metastability noise in addition to phase noise, has an operation which deviates from its stochastic model, which is not desirable.

### SUMMARY

There is a need to take into account, in a coherent sampling ring oscillator-based true random number generation circuit, metastabilities likely to occur in the flip-flop sampling an output signal of a first ring oscillator at the beginning of each rising or falling edge of an output signal of a second oscillator identical to the first oscillator.

An embodiment overcomes all or part of the disadvantages of known coherent sampling ring oscillator-based true random number generation circuits.

An embodiment provides a true random number generation circuit comprising:

a first ring oscillator and a second ring oscillator identical to the first one, configured to respectively deliver a first periodic signal and a second periodic signal;
a first flip-flop configured to sample the first signal at the beginning of each period of the second signal;
a counter clocked by the second signal; and
a metastability management circuit configured to:
remove output values of the counter resulting from metastabilities of the first flip-flop, and to reset the counter at each rising and/or falling edge of an output of the first flip-flop, or
generate a third metastability-free signal from at least the output of the first flip-flop, and to reset the counter at each rising edge and/or each falling edge of the third signal.

According to an embodiment, the metastability management circuit is configured to:

reset the counter at each rising and/or at each falling edge of the output of the first flip-flop; and
remove output values of the counter resulting from metastabilities of the first flip-flop by removing the output values of the counter smaller than a threshold at least partly determined by a setup time of the first flip-flop, a hold time of the first flip-flop, and a deviation between a mean value of the period of the first signal and a mean value of the period of the second signal.

According to an embodiment, the threshold is determined by the following formula:

$$Nmin = ( t s + t h ) / D T ,$$

with Nmin the threshold, ts the setup time, th the hold time, and DT the deviation between the mean value of the period of the first signal and the mean value of the period of the second signal.

According to an embodiment, the threshold is determined by the setup time of the first flip-flop, the hold time of the first flip-flop, the deviation between the mean value of the period of the first signal and the mean value of the period of the second signal, a standard deviation on the jitter of the first signal, and a standard deviation on the jitter of the second signal.

According to an embodiment, the threshold is determined by the following formula:

$$Nmin = ( t s + th + σ1 ) / ( DT + σ0 ) ,$$

with Nmin the threshold, ts the setup time, th the hold time, DT the deviation between the mean value of the period of the first signal and the mean value of the period of the second signal, σ1 the standard deviation on the jitter of the first signal, and σ0 the standard deviation on the jitter of the second signal.

According to an embodiment, the metastability management circuit is configured to reset the counter at each rising edge and at each falling edge of the output of the first flip-flop.

According to an embodiment, the metastability management circuit is configured to reset the counter at each rising edge and/or each falling edge of the third signal, and to generate the third signal by a majority vote between the output of the first flip-flop, P first samples obtained at each period of the second signal by sampling the first signal at P successive times delayed with respect to the beginning of said period, and of P second samples obtained at each period of the second signal by sampling at the beginning of said period P fourth signals delayed differently with respect to the first signal, P being an integer greater than or equal to 2.

According to an embodiment, at each period of the second signal:

the P successive times are delayed with respect to the beginning of said period by delays equal respectively to i*D, with D a time period and i an integer ranging from 1 to P; and
the P fourth signals are delayed with respect to the first signal by delays equal to j*D, with j an integer ranging from 1 to P.

According to an embodiment, time period D is at least partly determined by a setup time of the first flip-flop and a hold time of the first flip-flop.

According to an embodiment, a value of time period D is selected so that:

T01m/2>P*D>ts+th, with ts the setup time, th the hold time, and T01m a mean value of the periods of the first and second signal.

According to an embodiment, a value of time period D is selected so that:

T01m/2>P*D>ts+th+1+0, with ts the setup time, th the hold time, T01m a mean value of the periods of the first and second signal, σ1 a standard deviation on the jitter of the first signal, and σ0 a standard deviation on the jitter of the second signal.

According to an embodiment, the metastability management circuit comprises:

P first delay circuits configured to each receive the first signal and to respectively deliver the P fourth signals;
P second flip-flops identical to the first flip-flop and configured to respectively sample the P fourth signals at the beginning of each period of the second signal, so as to respectively deliver the P second samples;
P second delay circuits respectively identical to the P first delay circuits, and configured to each receive the second signal and to respectively deliver P fifth signals delayed differently with respect to the second signal; and

P third flip-flops identical to the first flip-flop and configured to sample the first signal at the beginning of each period of the P fifth signals respectively and to deliver the P first samples; and an arbitration circuit configured to receive the P first samples, the P second samples, and the output of the first flip-flop and to deliver the third signal based on the P first samples, the P second samples, and the output of the first flip-flop.

### BRIEF DESCRIPTION OF THE DRAWINGS

The foregoing features and advantages, as well as others, will be described in detail in the rest of the disclosure of specific embodiments given as an illustration and not limitation with reference to the accompanying drawings, in which:

FIG. 1, previously described, shows an example of a coherent sampling ring oscillator-based true random number generator circuit;

FIG. 2 shows timing diagrams of two signals of the circuit of FIG. 1;

FIG. 3 shows an embodiment of a coherent sampling ring oscillator-based true random number generator circuit;

FIG. 4 shows an example of distribution of output values of a counter of the circuit of FIG. 1;

FIG. 5 shows an example of an embodiment of a coherent sampling ring oscillator-based true random number generator circuit; and

FIG. 6 illustrates, in timing diagrams, the operation of the circuit of FIG. 5; and

FIG. 7 shows another example of a coherent sampling ring oscillator-based true random number generator circuit.

DETAILED DESCRIPTION OF THE PRESENT EMBODIMENTS

Like features have been designated by like references in the various figures. In particular, the structural and/or functional features that are common among the various embodiments may have the same references and may dispose identical structural, dimensional and material properties.

For the sake of clarity, only those steps and elements that are useful for understanding the described embodiments have been shown and are described in detail. In particular, known circuits used in a COSO-type true random number generation device to generate a random bit from an output N of a counter configured to count a number of periods of a first oscillator during a period or a half-period of an output signal Beat of a flip-flop sampling a second oscillator identical to the first one at the frequency of the first oscillator, have not been described. Indeed, the embodiments and variants described herein are compatible with these known circuits.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following description, where reference is made to absolute position qualifiers, such as the terms “front”, “back”, “top”, “bottom”, “left”, “right”, etc., or relative position qualifiers, such as the terms “top”, “bottom”, “upper”, “lower”, etc., or orientation qualifiers, such as “horizontal”, “vertical”, etc., reference is made unless otherwise specified to the orientation of the drawings.

Unless specified otherwise, the expressions “about”, “approximately”, “substantially”, and “in the order of” signify plus or minus 10% or 10°, preferably of plus or minus 5% or 5°.

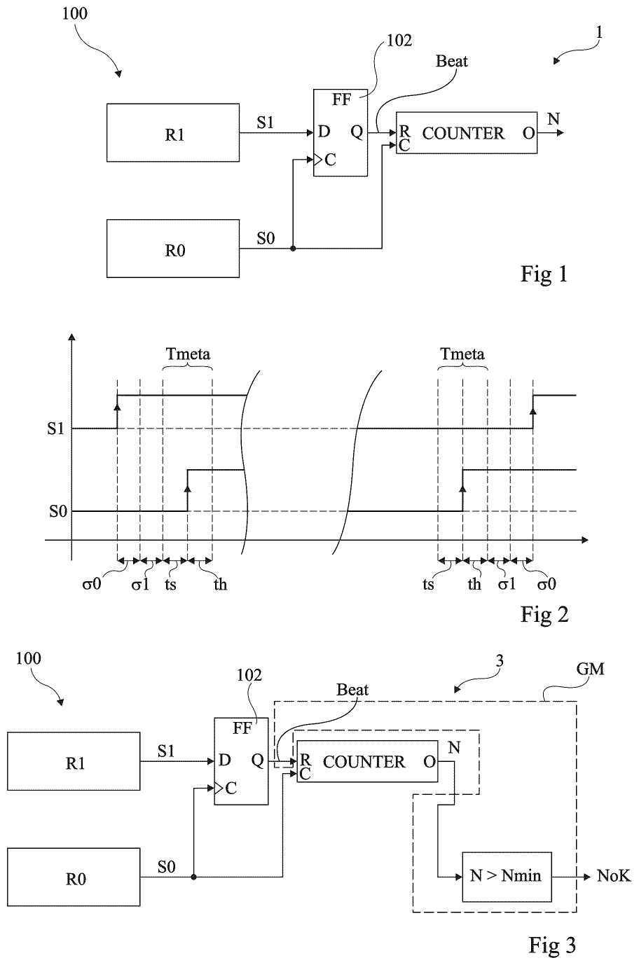

It is here provided to modify the device 1 of FIG. 1, to add thereto a metastability management circuit in flip-flop 102. This circuit is configured to:

control resettings of counter COUNTER, and
remove the N values which result from metastabilities in flip-flop 102, or directly generate a metastability-free signal Beat from at least the output of flip-flop 102.

Signal Beat is said to be metastability-free, for example, when the effects of a metastable state of flip-flop 102 on the value of signal Beat have been removed.

For example, metastability-free signal Beat is generated from:

samples of signal S1 obtained at the output of flip-flop 102,
samples of signals corresponding to delayed versions of signal S1, these samples being synchronous with the sampling of signal S1 by flip-flop 102,
other samples of signal S1 obtained at sampling times shifted in time with respect to the times of sampling of signal S1 by flip-flop 102, and
a majority vote between these samples.

Preferably, the metastability management circuit is configured so as not to unbalance the load seen by the output of each of oscillators R0 and R1 as compared with the case where this circuit is omitted. In other words, the metastability management circuit is configured so as not to introduce asymmetries between the load seen by oscillator R0 and that seen by oscillator R1, as compared with the case where this circuit is omitted. Thus, the stochastic models used to characterize the entropy source remain advantageously valid.

FIG. 2 shows timing diagrams of two signals of the circuit of FIG. 1. More particularly, FIG. 2 shows signals S1 and S0 at a time when signal S1 is ahead of phase with respect to signal S0 (to the left in FIG. 2) and at a time when signal S1 lags in phase with respect to signal S0 (to the right in FIG. 2).

In the rest of the description, there is called “active edge” of signal S0 the edge type from among the rising type and the falling type which causes a sampling of signal S1 by flip-flop 102. In the example of FIG. 2, the active edges of signal S0 are the rising edges, although an example based on active falling edges is possible.

In FIG. 2, the setup time ts of flip-flop 102 and the hold time th of flip-flop 102 are shown. Time ts is the duration preceding each active edge of signal S0 during which signal S1 needs to have a stable value, and time th is the duration following each active edge of signal S0 during which signal S1 needs to have a stable value. If signal S1 has a stable value during times ts and th, then flip-flop 102 does not have a metastable state.

These times ts and th define, for each active edge of signal S0, a time window Tmeta during which a change in the value of signal S1 can lead to a metastable state of flip-flop 102, that is, to a binary value of signal Beat which does not correspond to the binary value of signal S1 at the time of the active edge of signal S0.

There is called DT the deviation between the average duration of periods T0 and T1. This deviation is for example set by an active control, as described as an example in relation with FIG. 1. As an alternative example, this deviation is determined during a phase of design of oscillators R0 and R1. As another alternative example, this deviation is determined during a phase of post-fabrication characterization of circuit 1.

When the phase between signals S1 and S0 is such that an edge of signal S1 occurs at the beginning of the duration Tmeta of a corresponding active edge of signal S0, knowing DT, ts, and th, it is then possible to determine the number Nmin of periods T0 of the signal which must elapse before the phase between signals S1 and S0 is such that an edge of signal S1 no longer occurs during the duration Tmeta of a corresponding active edge of signal S0.

According to an embodiment, this number Nmin is at least partly determined based on deviation DT and on the times or durations ts and th of flip-flop 102.

For example, number Nmin is determined by the following relation:

Nmin=(ts+th)/DT.

As an alternative example, number Nmin is determined by further taking into account the jitter on signals S1 and S0, that is, the standard deviation σ1 on the jitter of signal S1 and the standard deviation σ0 on the jitter of signal S0. For example, in the case where signal S1 is ahead of signal S0 in phase (to the left in FIG. 2), for a given phase value where the edges of signal S1 would not occur within the periods Tmeta of the corresponding active edges of signal S0, due to the fact that the jitter of signal S1 and the jitter of signal S0 can decrease the phase deviation between signals S1 and S0, the edges of signal S1 can in practice occur within the duration Tmeta of corresponding active edges of signal S0. Symmetrically, in the case where signal S1 lags signal S0 in phase (to the right in FIG. 2), for a given phase value where the edges of signal S1 would not occur during the periods Tmeta of the corresponding active edges of signal S0, due to the fact that the jitter of signal S1 and the jitter of signal S0 can decrease the phase deviation between signals S1 and S0, and edges of signal S1 may in practice occur during the duration Tmeta of corresponding active edges of signal S0. In this case, to take into account the jitter of signals S1 and S0 statistically characterized by the respective standard deviations σ1 and σ0, number Nmin is determined by the following relation:

Nmin=(ts+th+σ1)/(DT+σ0).

More generally, the number Nmin of periods T0 of the signal which need to elapse before the phase between signals S1 and S0 is such that an edge of signal S1 no longer occurs during the duration Tmeta of a corresponding active edge of signal S0 can be determined otherwise than based on at least deviation DT and the durations ts and th of flip-flop 102, for example empirically, by means of a prior statistical analysis. For example, a calibration step may be implemented to obtain a statistical distribution of values N, and Nmin may be selected so that the values N below Nmin correspond to count values resulting from a metastability.

In practice, the values N of the counter which are lower than Nmin are values N for which metastabilities in the flip-flop have given rise to unintended or unwanted oscillations of signal Beat, and thus to unintended or unwanted resettings of counter COUNTER. These values N smaller than Nmin are thus not only representative of the phase noise, or jitter, of signals S0 and S1, but also of metastability phenomena in flip-flop 102.

The metastability management circuit thus removes the values N which are lower than thresholds Nmin. In this case, circuit COUNTER remains reset by the output signal Beat of flip-flop 102, which is directly transmitted by the metastability management circuit to the R input of circuit COUNTER. However, when metastabilities lead to unwanted oscillations of signal Beat, and thus in an untimely resetting of circuit COUNTER and in a value N lower than Nmin, this value N is removed by the metastability management circuit. The removed values N are thus not transmitted to the digital circuits, which use the output N of counter COUNTER to generate a random bit.

FIG. 3 shows an embodiment of a coherent sampling ring oscillator-based true random number generator circuit 3, in the case where this circuit 3 comprises a metastability management circuit GM such as described hereabove.

Device 3 has many features in common with the device 1 of FIG. 1, and only the differences between these two devices are here highlighted. Thus, unless otherwise indicated, all that has been described in relation with FIG. 1 applies to the device 3 of FIG. 3.

Device 3 comprises entropy source 100, which is unchanged with respect to that of FIG. 1. Thus, the known stochastic models used to model source 100 in order to characterize device 1 apply to the entropy source 100 of device 3 to characterize device 3.

As compared with device 1, device 3 further comprises circuit GM delimited by dotted lines in FIG. 3.

Circuit GM is configured to remove (or filter) the values N which are smaller than the above-described threshold Nmin. Thus, circuit GM receives the output values N of circuit COUNTER, and delivers corresponding values Nok. Values Nok are the values N which are greater than threshold Nmin. This function of circuit GM is shown in FIG. 3 in the form of a block 300 (“N>Nmin” in FIG. 3). For example, this block 300 comprises a digital circuit for comparing each received value N with threshold Nmin, and a circuit configured to deliver a value Nok equal to the received value N only if this received value N is greater than threshold Nmin. In other words, block 300 corresponds, for example, to an ideal digital high-pass filter having a cut-off value Nmin.

Circuit GM is further configured to control the resettings of counter COUNTER.

According to an embodiment, circuit GM is configured to reset circuit COUNTER at each rising edge of signal Beat, or at each falling edge of signal Beat. In this case, the output values N of counter COUNTER which do not result from metastability correspond to the number of periods T0 of signal S0 during a period of signal Beat which has not been affected by metastabilities in flip-flop 102. As an example, circuit is configured to directly supply signal Beat to the R input of circuit COUNTER, this R input being active on rising edges when rising edges of signal Beat cause the resetting of circuit COUNTER, and on falling edges when falling edges of signal Beat cause the resetting of circuit COUNTER.

According to an alternative embodiment, circuit GM is configured to reset circuit COUNTER at each rising edge of signal Beat and at each falling edge of signal Beat. In this case, the output values N of counter COUNTER which do not result from metastability correspond to the number of periods T0 of signal S0 during a half-period of signal Beat which has not been affected by metastabilities in flip-flop 102. As an example, circuit GM is configured to deliver signal Beat directly to the R input of circuit COUNTER, this R input being active on rising edges and on falling edges, whereby each rising edge and each falling edge of signal Beat causes a resetting of circuit COUNTER.

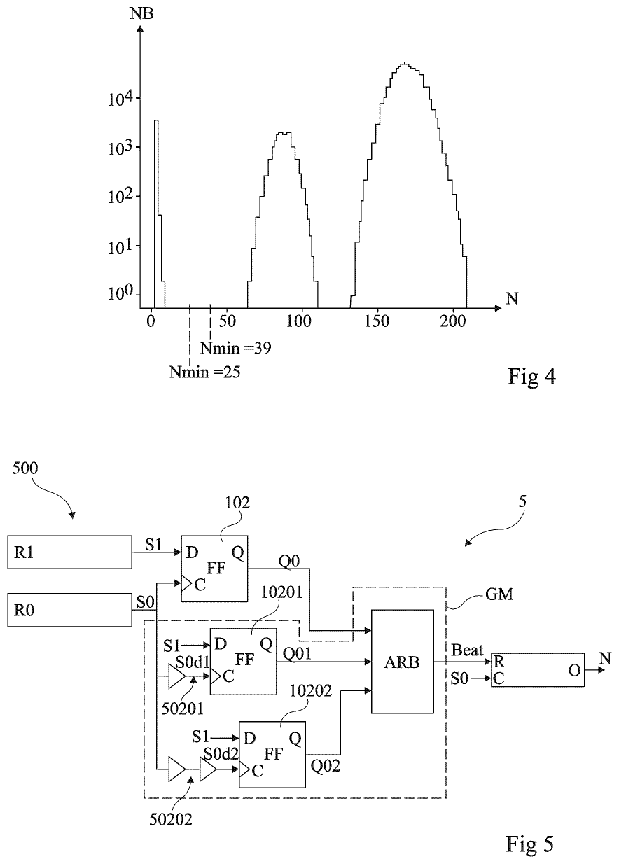

FIG. 4 shows an example of distribution of the output values N of the counter COUNTER of the circuit 100 of FIG. 1. In this example, one of oscillators R1 and R0 operates with a 500-MHz average frequency, and the other of oscillators R1 and R0 operates with 503-MHz average frequency. As an example, threshold Nmin is equal to 25 when it is calculated with the formula Nmin=(ts+th)/DT, and 39 when it is calculated with the formula Nmin=(ts+th+σ1)/(DT+σ0). In the example of FIG. 4, circuit COUNTER is reset only on rising edges of signal Beat, or, as a variant, only on falling edges of signal Beat.

The numerical values of the output N of counter COUNTER are shown in abscissas, and the number NB of outputs N equal to each numerical value N in abscissas is indicated in logarithmic scale in ordinates.

A peak 400 represents the values N for which signal Beat has undergone unwanted binary value changes at the beginning of a period of signal Beat due to metastability in the flip-flop 102. These unwanted oscillations of signal Beat at the beginning of a period of signal Beat cause close resettings of circuit COUNTER which are the result of metastabilities in flip-flop 102. The outputs N corresponding to peak 400 are effectively removed by circuit GM, due to the fact that they correspond to values lower than Nmin.

A peak 402 represents the values N for which signal Beat has undergone no metastability from the beginning to the end of a period of signal Beat. These values N are thus representative of the number of periods T1 of signal S0 during a period of signal Beat in the absence of metastability in flip-flop 102, and their distribution around a mean value is only the result of the jitter on signals S0 and S1.

An additional peak 404 represents values N for which signal Beat has not undergone untimely binary value changes at the beginning of a period of signal Beat, but has undergone untimely binary value changes in the middle of this period due to metastabilities in flip-flop 102, whereas, in the absence of metastability, signal Beat should only have switched once. These unwanted oscillations of signal Beat in the middle of a period of signal Beat cause resettings of circuit COUNTER, which are the result of metastabilities in flip-flop 102.

Preferably, to prevent for the output values Nok of the circuit GM of FIG. 4 to be representative not only of the duration of one period of signal Beat but also of the duration of half a period of signal Beat, circuit GM and circuit COUNTER are configured so that circuit COUNTER is reset at each rising edge and at each falling edge of signal Beat. In this case, circuit COUNTER together with circuit GM deliver values Nok which are effectively equal to the number of periods T0 of signal S0 during a half-period of signal Beat in the absence of metastability in flip-flop 102. As an example, by adding two successive values Nok, which correspond to the number of periods T0 of signal S0 in respectively two successive half-periods of one period of signal S0, a value representative of the number of periods T0 of signal S0 in this period of signal Beat is obtained.

The circuit GM described in relation with FIGS. 2, 3, and 4 is configured to control resettings of counter COUNTER and to remove the values N which result from metastabilities in flip-flop 102.

A circuit GM configured to control resettings of counter COUNTER and to directly generate a metastability-free signal Beat will now be disclosed in relation with FIGS. 5, 6, and 7.

FIG. 5 shows an example of a coherent sampling ring oscillator-based true random number generator circuit 5, in the case where this circuit 5 comprises a metastability management circuit GM such as described hereabove. Circuit GM is delimited by dotted lines in FIG. 5.

Device 5 has many features in common with the device 1 of FIG. 1, and only the differences between these two devices are here highlighted. Thus, unless otherwise indicated, all that has been described in relation with FIG. 1 applies to the device 5 of FIG. 5.

Device 5 comprises, like the device 1 of FIG. 1, the two oscillators R0 and R1 and flip-flop 102, receiving signal S1 on its D input and signal S0 on its C input. However, in FIG. 5, the signal Beat representative of the phase between signals S1 and S0 is not the output signal of flip-flop 102, which is designated with reference Q0 in FIG. 5, but is generated by circuit GM from this output Q0 so that signal Beat is free of metastability. Circuit GM thus receives output Q0 from flip-flop 102.

Circuit 5 comprises counter COUNTER. The D input of counter COUNTER receives signal S0, and the R input of counter COUNTER receives the signal Beat delivered by circuit GM. This R input may be active on rising edges only, on falling edges only, or on rising and falling edges. The output O of circuit COUNTER provides value N equal to the number of periods T0 of signal S0 counted during each period of signal Beat if the R input is active on rising edges only, or on falling edges only, and to the number of periods T0 of signal S0 counted during each half-period of signal Beat if the R input is active both on rising edges and on falling edges.

Circuit GM is here configured to generate signal Beat by implementing a majority vote between:
the output Q0 of flip-flop 102, that is, the sample available at the Q output of flip-flop 102; and
P samples Q0i, with P an integer greater than 2 and i an integer index ranging from 1 to P, obtained at each period of signal S0 by sampling the signal at P successive times delayed with respect to the beginning of the period of signal S0, that is, delayed with respect to the time of sampling of signal S1 by flip-flop 102.

In FIG. 5, P is equal to 2, and circuit GM thus generates, at each period of signal S0, a sample Q01 and a sample Q02, corresponding to two successive sampling times delayed with respect to the time of sampling of signal S1 by flip-flop 102.

According to an embodiment, at each period of signal S0, flip-flop 102 samples signal S1 at the beginning of the period, and the P successive sampling times are delayed with respect to the beginning of the period by delays respectively equal to i*D, with D a time period.

For example, in FIG. 5, at each period of signal S0, flip-flop 102 samples signal S1 at the beginning of the period, and the P=2 successive sampling times corresponding to samples Q01 and Q02 are delayed with respect to the beginning of the period by delays respectively equal to 1*D and 2*D.

For example, duration D is at least partly determined by the time ts and the time th of flip-flop 102. For example, the largest delay equal to P*D is greater than a duration of a time window in which metastabilities can occur, this window being at least partly determined by the time ts and the time th of flip-flop 102, for example at least partly determined by ts+th. Further, this longest delay equal to P*D is preferably shorter than the average half-period of oscillators R0 and R1.

For example, when the time window during which metastabilities can occur is equal to ts+th, duration D is only determined by times ts and th, and is selected so that T01m/2>P*D>ts+th, with T01m the mean value of periods T0 and T1.

As an alternative example, value D is determined by times th and ts and, in addition, by the jitter on signal S0 and the jitter on signal S1. For example, the time window during which metastabilities can occur is then equal to ts+thσ1+σ0, duration D is determined by the sum ts+thσ1+σ0, and duration D is selected so that T01m/2>P*D>ts+th+σ1+σ0.

As an example, circuit GM comprises P delay circuits 5020i (50201 and 50202 in the example of FIG. 5, where P is equal to 2) and P flip-flops 1020i (10201 and 10202 in the example of FIG. 5, where P is equal to 2), flip-flops 1020i all being identical to flip-flop 102. Each delay circuit 5020i receives signal S0 and delivers a corresponding delayed version S0d1 of this signal S0. For example, each signal S0d1 has a delay equal to i*D relative to signal S0. Each flip-flop 1020i is configured to sample signal S1 at the beginning of each period of the corresponding signal S0d1. For example, flip-flop 1020A, respectively 10202, is configured to sample signal S1 at each beginning of a period of signal S0d1, respectively S0d2, so as to deliver sample Q0d1, respectively Q0d2. For example, each flip-flop 1020i receives signal S1 on its D input, signal S0d1 on its C input, and delivers signal or sample Q0di on its Q output.

Circuit GM comprises an arbitration circuit ARB configured to receive samples Q0 and Q0i, and to deliver the signal Beat corresponding to the result of a majority vote between these samples.

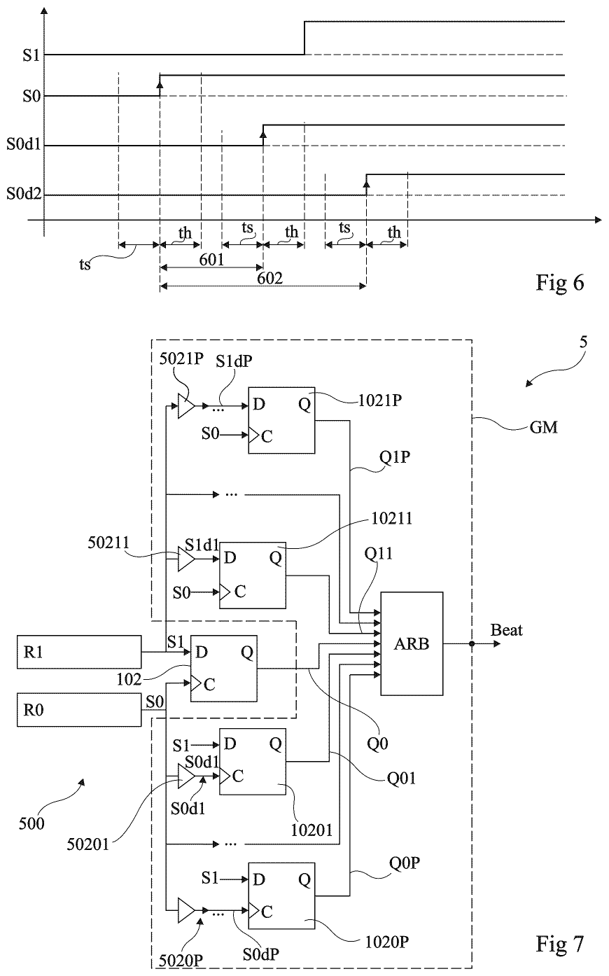

FIG. 6 illustrates, in timing diagrams, the operation of the circuit 5 of FIG. 5.

More particularly, FIG. 6 shows the timing diagrams of signals S1, S0, S0d1, and S0d2.

In this example, the active edges of signal S0 are the rising edges, that is, each period of signal S0 corresponds to a rising edge of this signal. Thus, in this example, the active edges of signals S0d1 and S0d2 causing the sampling of signal S1 by the respective flip-flops 10201 and 10202 are also the rising edges of these signals, and each period of signal S0d1, respectively S0d2, thus begins with a rising edge of this signal S0d1, respectively S0d2.

FIG. 6 shows the delay 601, for example equal to 1*D, of signal S0d1 with respect to signal S0, and the delay 602, for example equal to 2*D, of signal S0d2 with respect to signal S0.

Further, in FIG. 6, the times ts and th of flip-flop 102 around each active edge of signal S0 are shown, the times ts and th of flip-flop 10201 around each active edge of signal S0d1 are shown, and the times ts and th of flip-flop 10202 around each active edge of signal S0d2 are shown.

As can be seen in FIG. 6, an edge of signal S0 which occurs during the time ts or th of an active edge of one of signals S0d1 and S0, that is, signal S0d1 in the example of FIG. 6, does not occur during the times ts or th of a corresponding edge of the other signals Sd0i and S0, that is, signals S0d2 and S0 in the example of FIG. 6.

Thus, even if one of samples Q0 and Q0i is unstable due to a metastable state of the flip-flop having delivered this sample, the value of signal Beat resulting from the majority vote between samples Q0 and Q0di will be stable and free of the effects of this metastable state.

Table 1 hereafter gives, for all combinations of values of samples Q0 and Qdi, the corresponding value of signal Beat.

TABLE 1

| Q0 | Q01 | Q02 | Beat |
|---|---|---|---|
| 0 | 0 | 0 | 0 |
| 0 | 0 | 1 | 0 |
| 0 | 1 | 0 | X |
| 0 | 1 | 1 | 1 |
| 1 | 0 | 0 | 0 |
| 1 | 0 | 1 | X |
| 1 | 1 | 0 | 1 |
| 1 | 1 | 1 | 1 |

It should be noted that, in practice, the combination Q0=0, Qd1=1, and Qd2=0 cannot occur, nor can the combination Q0=1, Qd1=0, and Qd2=1.

In the above example of FIGS. 5 and 6, P is equal to 2. However, the higher the value of P, the higher the confidence in the vote. Thus, preferably, P is selected to be greater than or equal to 3.

In FIG. 5, the assembly of the two oscillators R1 and R0, of flip-flop 102, and of circuit GM implement an entropy source 500 in which the effects of the metastability of flip-flop 102, and, in practice, of the other flip-flops 1020i, are removed from the signal Beat delivered by this entropy source 500. In this case, the variation in the duration of each half-period or of each period of signal Beat is then only linked to the jitter of signals S1 and S0.

However, to characterize source 500, known stochastic models are no longer totally valid. Indeed, the provision of circuit GM as described in FIG. 5 provides an additional load on the output of oscillator R0, without accordingly modifying the load on the output of oscillator R1. As a result, the operation of the two oscillators R0 and R1 is no longer totally identical, conversely to what is generally provided in known stochastic models.

This problem can be addressed by a circuit GM of the type described hereafter in relation with FIG. 7.

FIG. 7 shows another example an embodiment of the coherent sampling ring oscillator-based true random number generator circuit 5.

The device 5 of FIG. 7 has many features in common with the device 5 of FIG. 5, and only the differences between these two devices are here highlighted. Thus, unless otherwise indicated, all that has been described in relation with FIG. 5 applies to the device 5 of FIG. 7. The device 5 of FIG. 7 differs from the device 5 of FIG. 5 by its circuit GM.

Circuit GM is here configured to generate signal Beat by implementing a majority vote between:
the output Q0 of flip-flop 102, that is, the sample available at the Q output of flip-flop 102;
P samples Q0i (Q01 and Q0P in FIG. 7), with P an integer greater than 2 and i an integer index ranging from 1 to P, obtained at each period of signal S0 by sampling the signal at P successive times delayed with respect to the beginning of the period of signal S0, that is, delayed with respect to the time of sampling of signal S1 by flip-flop 102; and
   P samples Q1j (Q1d1 and Q1dP in FIG. 7) obtained at each period of signal S0 by sampling, at the beginning of this period, P signals S1dj (S1d1 and S1dP in FIG. 7) delayed differently with respect to signal S1, with j an integer ranging from 1 to P.

Thus, circuit GM may be implemented symmetrically, that is, so that the load seen by oscillator R0 on its output is the same as the load seen by oscillator R1 on its output. Known stochastic models enabling to characterize entropy source 100 (FIG. 1 or 2) may be reused to characterize the entropy source 500 comprising oscillators R0 and R1, flip-flop 102, and circuit GM.

According to an embodiment, at each period of signal S0, flip-flop 102 samples signal S1 at the beginning of the period, and the P signals S1i are delayed with respect to signal S1 by delays respectively equal to j*D.

For example, in FIG. 7, at each period of signal S0, flip-flop 102 samples signal S1 at the beginning of the period, and at this same sampling time, each of signals S1di is sampled by circuit GM.

As an example, the circuit GM of FIG. 7 comprises, like the circuit GM of FIG. 5, P delay circuits 5020i (50201 and 5020P in the example of FIG. 7), P flip-flops 1020i (10201 and 1020P in the example in FIG. 7), P delay circuits 5021j (50211 and 5021P in the example of FIG. 7), and P flip-flops 1021j (10211 and 1021P in the example of FIG. 7), the flip-flops 1020i and 1021j all being identical to flip-flop 102. Each delay circuit 5020i receives signal S0 and delivers a corresponding delayed version S0di of this signal S0. Each circuit 5021j receives signal S1 and delivers a corresponding delayed version S1dj (S1d1 and S1dP in FIG. 7) of this signal. For example, each signal S0d1 exhibits a delay equal to i*D with respect to signal S0, and each signal S1dj exhibits a delay equal to j*D with respect to signal S1. In other words, the P circuits 5021j are, for example, respectively identical to the P circuits 5020i. Each flip-flop 1020i is configured to sample signal S1 at the beginning of each period of the corresponding signal S0d1. For example, each flip-flop 1020i receives signal S1 on its D input, signal S0d1 on its C input, and delivers signal or sample Q0di on its Q output. Each flip-flop 1021j is configured to sample the signal S1dj corresponding to the beginning of each period of signal S0. For example, each flip-flop 1021j receives signal S1dj on its D input, signal S0 on its C input, and delivers signal or sample Q1dj on its Q output.

Circuit GM comprises arbitration circuit ARB, with the difference that, in the example of FIG. 7, circuit ARB is configured to receive samples Q0, Q0i, and Q1j, and to deliver the signal Beat corresponding to the result of a majority vote between these samples.

Various embodiments and variants have been described. Those skilled in the art will understand that certain features of these various embodiments and variants may be combined, and other variants will occur to those skilled in the art. For example, although this has been described, those skilled in the art could provide another example of a circuit GM of the type described in relation with FIGS. 5 to 7, providing for signal Beat to be the result of a majority vote only between sample Q0 and samples Q1dj, that is, for example, by removing circuits 5020i and 1020i from the circuit GM of FIG. 7 and by adapting the circuit ARB of this circuit GM. As a further example, in the devices 5 of FIGS. 5 and 7, delay circuits 5020i and/or 5021j may be omitted, the respective signals S0d1 and S1dj then corresponding to internal signals of the respective oscillators R0 and/or R1. However, although such an example is functionally identical to the examples of device 5 described in relation with FIGS. 5 and 7, its implementation requires connecting the inputs of flip-flops 1020i and/or 1021j directly to internal nodes of the respective oscillators R0 and/or R1, whereby the stochastic model of the entropy source will have to be adapted with respect to known models.

Finally, the practical implementation of the described embodiments and variants is within the abilities of those skilled in the art based on the functional indications given hereabove.

1. True random number generation circuit comprising:
a first ring oscillator and a second ring oscillator identical to the first one, configured to respectively deliver a first periodic signal and a second periodic signal;
a first flip-flop configured to sample the first signal at the beginning of each period of the second signal;
a counter clocked by the second signal; and
a metastability management circuit configured to:
remove output values of the counter resulting from metastabilities of the first flip-flop, and to reset the counter at each rising edge and/or at each falling edge of an output of the first flip-flop, or
generate a third metastability-free signal from at least the output of the first flip-flop, and to reset the counter at each rising edge and/or each falling edge of the third signal.

2. Circuit according to claim 1, wherein the metastability management circuit is configured to:
reset the counter at each rising and/or at each falling edge of the output of the first flip-flop; and
remove the output values of the counter resulting from metastabilities of the first flip-flop by removing the output values of the counter smaller than a threshold (Nmin) at least partly determined by a setup time of the first flip-flop, a hold time of the first flip-flop, and a deviation between a mean value of the period of the first signal and a mean value of the period of the second signal.

3. Circuit according to claim 2, wherein the threshold (Nmin) is determined by the following formula:
$$Nmin = ( t s + t h ) / D T ,$$
where Nmin is the threshold, ts is the setup time, th is the hold time, and DT is the deviation between the mean value of the period of the first signal and the mean value of the period of the second signal.

4. Circuit according to claim 2, wherein the threshold is determined by the setup time of the first flip-flop, the hold time of the first flip-flop, the deviation between the mean value of the period of the first signal and the mean value of the period of the second signal, a standard deviation (σ1) on the jitter of the first signal and a standard deviation on the jitter of the second signal.

5. Circuit according to claim 4, wherein the threshold is determined by the following formula:
$$Nmin = ( t s + th + σ1 ) / ( DT + σ0 ) ,$$
with Nmin the threshold, ts the setup time, th the hold time, DT the deviation between the mean value of the period of the first signal and the mean value of the period of the second signal, σ1 the standard deviation on the jitter of the first signal, and σ0 the standard deviation on the jitter of the second signal.

6. Circuit according to claim 2, wherein the metastability management circuit is configured to reset the counter at each rising edge and at each falling edge of the output of the first flip-flop.

7. Circuit according to claim 1, wherein the metastability management circuit is configured to reset the counter at each rising edge and/or each falling edge of the third signal, and to generate the third signal by a majority vote between the output of the first flip-flop, P first samples obtained at each period of the second signal by sampling the first signal at P successive times delayed with respect to the beginning of said period, and P second samples obtained at each period of the second signal by sampling at the beginning of said period P fourth signals delayed differently with respect to the first signal, P being an integer greater than or equal to 2.

8. Circuit according to claim 7, wherein, at each period of the second signal:
the P successive times are delayed with respect to the beginning of said period by delays equal respectively to i*D, with D a time period and i an integer ranging from 1 to P; and
the P fourth signals are delayed with respect to the first signal by delays respectively equal to j*D, with j an integer from 1 to P.

9. Circuit according to claim 8, wherein time period D is at least partly determined by a setup time of the first flip-flop and a hold time of the first flip-flop.

10. Circuit according to claim 9, wherein a value of time period D is selected so that:
T01m/2>P*D>ts+th, with ts the setup time, th the hold time, and T01m a mean value of the periods of the first and second signal.

11. Circuit according to claim 9, wherein a value of time period D is selected so that:
T01m/2>P*D>ts+th+σ1+σ0, with ts the setup time, th the hold time, T01m a mean value of the periods of the first and second signal, σ1 a standard deviation on the jitter of the first signal, and σ0 a standard deviation on the jitter of the second signal.

12. Circuit according to claim 8, wherein the metastability management circuit comprises:
P first delay circuits configured to each receive the first signal and to respectively deliver the P fourth signals;
P second flip-flops identical to the first flip-flop and configured to respectively sample the P fourth signals at the beginning of each period of the second signal so as to respectively deliver the P second samples;
P second delay circuits q identical respectively to the P first delay circuits, and configured to each receive the second signal and to respectively deliver P fifth signals delayed differently with respect to the second signal; and
P third flip-flops identical to the first flip-flop and configured to sample the first signal at the beginning of each period of the P fifth signals respectively and deliver the P first samples; and
an arbitration circuit (ARB) configured to receive the P first samples, the P second samples, and the output of the first flip-flop and to deliver the third signal based on the P first samples, the P second samples, and the output of the first flip-flop.
